(19) United States
(12) Patent Application Publication
(10) Pub. No.: US 2011/0032407 A1
(43) Pub. Date: Feb. 10, 2011

(54) DISPLAY APPARATUS, DISPLAY METHOD, AND DISPLAY PROGRAM

(75) Inventor: Ryoko Amano, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/844,161

(22) Filed: Jul. 27, 2010

(30) Foreign Application Priority Data
Aug. 5, 2009 (JP) 2009-182775

(51) Int. Cl. H04N 5/222

(52) U.S. Cl. 348/333.05; 348/E05.022

(57) ABSTRACT

A display apparatus includes: a display section that displays an image; and a control section that allows the display section to display a plurality of images, which are included in a predetermined group, in series on the basis of a predetermined operation performed on an input section, and allows the display section to display predetermined information while allowing the display section to display an endmost image in the corresponding predetermined group.

### BACKGROUND OF THE INVENTION

1. Field of the Invention

The present invention relates to a display apparatus, a display method, and a display program, and is appropriately applied, for example, when images are displayed in series.

2. Description of the Related Art

Recently, display apparatuses, which display a plurality of images captured by, for example, a digital still camera and the like in series in an optional order (for example, in an order of the shooting date and time), have come into widespread use.

As such a display apparatus, there has been proposed an apparatus that displays images, for example, by changing the images sequentially in accordance with the elapse of the predetermined time in a slide show format (for example, refer to Japanese Unexamined Patent Application Publication No. 2006-238012 (11th figure)).

Further, there has been also proposed a display apparatus that displays images in series (that is, scrolls the images) in accordance with the operation performed on an input section such as, for example, a touch panel.

### SUMMARY OF THE INVENTION

The above-mentioned display apparatus may be configured to display images in series for each predetermined group (for example, for each shooting date or folder) in accordance with the operation performed on the input section.

In this case, for example, while the last image in the corresponding group is displayed, when an operation to change to the next image is performed, the first image may be returned to and displayed. Specifically, a plurality of images may be looped together and displayed.

However, when the above-mentioned configuration is applied, the images are endlessly looped and continuously displayed in accordance with an operation to change to the next image. Thus, it is difficult to figure out which one is the first or last image, that is, which one is the endmost image. Therefore, in such a display apparatus, it is difficult to make a user distinctively recognize the endmost image and the other images.

The invention has been made in view of the above, and it has been proposed to provide a display apparatus, a display method, and a display program capable of making a user to distinctively recognize the endmost image when displaying images in series.

According to an embodiment of the invention, a display apparatus includes: a display section that displays an image; and a control section that allows the display section to display a plurality of images, which are included in a predetermined group, in series on the basis of a predetermined operation performed on an input section, and allows the display section to display predetermined information while allowing the display section to display an endmost image in the corresponding predetermined group.

With such a configuration, the display apparatus according to the embodiment of the invention is able to make a user distinctively recognize the endmost image and the other images in the predetermined group, for example, even when looping and displaying the plurality of images.

According to the embodiment of the invention, it is possible to make a user distinctively recognize the endmost image and the other images in the predetermined group, for example, even when looping and displaying the plurality of images. With such a configuration, it is possible to embody a display apparatus, a display method, and a display program capable of making a user distinctively recognize the endmost image when displaying the images in series.

### BRIEF DESCRIPTION OF THE DRAWINGS

FIG. 1 is a function block diagram schematically illustrating an embodiment;

FIGS. 2A and 2B are schematic diagrams illustrating an exterior configuration of a DSC (a digital still camera);

FIG. 3 is a block diagram illustrating a hardware configuration of the DSC (the digital still camera);

FIGS. 4A and 4B are schematic diagrams illustrating a single display screen (1);

FIGS. 5A and 5B are schematic diagrams illustrating an index display screen (1);

FIGS. 6A to 6D are schematic diagrams illustrating scroll processing (1) in an index display mode;

FIG. 7 is a schematic diagram illustrating an index display screen (2);

FIG. 8 is a schematic diagram illustrating a mute screen;

FIGS. 9A to 9C are schematic diagrams illustrating scroll processing (2) in the index display mode;

FIGS. 10A to 10C are schematic diagrams illustrating scroll processing (3) in the index display mode;

FIG. 11 is a schematic diagram illustrating an index display screen (3);

FIGS. 12A and 12B are schematic diagrams illustrating scroll processing (4) in the index display mode;

FIG. 13 is a flowchart illustrating an index scroll processing order;

FIG. 14 is a flowchart continued from the flowchart illustrating the index scroll processing order of FIG. 13;

FIG. 15 is a schematic diagram illustrating a tap operation performed on a move-to-first button;

FIG. 16 is a schematic diagram illustrating a single display screen (2);

FIG. 17 is a schematic diagram illustrating a tap operation performed on the move-to-last button; and

FIG. 18 is a schematic diagram illustrating a single display screen (3).

### DESCRIPTION OF THE PREFERRED EMBODIMENTS

Hereinafter, the preferred embodiments (hereinafter referred to as embodiments) will be described. Furthermore, description will be given in the following order.

1. Embodiment

2. Other Embodiments

### 1. Embodiment

### 1-1. Summary of Embodiment

First, a summary of the embodiment will be described. After the summary is described, specific examples of the embodiment are described.

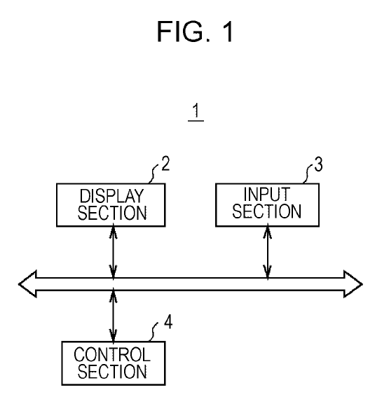

In FIG. 1, the reference numeral 1 indicates a display apparatus. The display apparatus 1 has a display section 2 that displays an image. In addition, the display apparatus 1 has a control section 4 that allows the display section 2 to display a plurality of images, which are included in a predetermined group, in series on the basis of the predetermined operation performed on the input section 3. The control section 4 allows the display section 2 to display predetermined information while allowing the display section 2 to display the endmost image in the corresponding predetermined group.

With such a configuration, the display apparatus 1 is able to make a user distinctively recognize the endmost image and other images in a predetermined group, for example, even when looping and displaying the plurality of images.

Specific examples of the display apparatus 1 configured in such a manner will hereinafter be described in detail.

### 1-2. Exterior Configuration of DSC (Digital Still Camera)

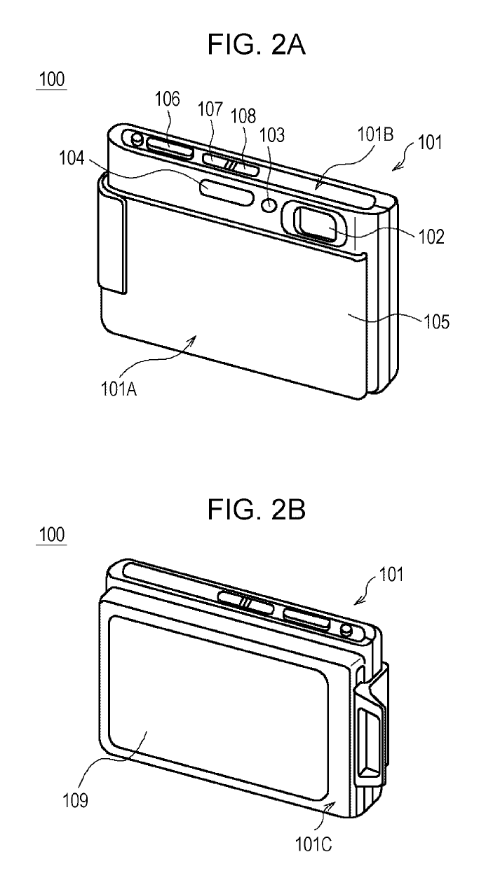

Next, with reference to FIGS. 2A and 2B, an exterior configuration of a digital still camera (hereinafter, referred to as a DSC) 100 as a specific example of the above-mentioned display apparatus 1 is described.

The DSC 100 has a casing 101 formed in a substantially flat rectangle shape having a size which can be held in one hand. On a front surface 101A of the casing 101, a photographic lens 102, an AF (Auto Focus) illuminator 103, and a flash 104 are provided. The AF illuminator 103 doubles as a self timer lamp.

Moreover, a lens cover 105 which can be slid up and down is mounted on the front surface 101A. The lens cover 105 is configured to expose the photographic lens 102, the AF illuminator 103, and the flash 104 when being slid down, or to cover those for protection when being slid up.

Furthermore, the DSC 100 is configured to be automatically turned on when the lens cover 105 is slid down.

Further, on an upper surface 101B of the casing 101, a shutter button 106, a playback button 107, and a power button 108 are provided. Furthermore, a touch screen 109 is provided on a rear surface 101C of the casing 101.

A playback button 107 is a hardware key to change an operation mode of the DSC 100 into a playback mode which displays the captured image on the touch screen 109. Further, the touch screen 109 is a display device capable of a touch operation performed by a user's finger (or a pen or the like).

The DSC 100 is turned on when the lens cover 105 is slid down or when the power button 108 is pressed down, and is thereby activated in a photography mode.

Then, the DSC 100 displays an image, which is captured through the photographic lens 102, as a monitoring image on the touch screen 109. The DSC 100 stores the image when the shutter button 106 is pressed down.

Further, the DSC 100 is changed to be in the playback mode when the playback button 107 is pressed. Then, the DSC 100 displays, for example, one of the stored images on the touch screen 109. The DSC 100 changes the displayed image in accordance with the touch operation performed on the touch screen 109.

### 1-3. Hardware Configuration of DSC (Digital Still Camera)

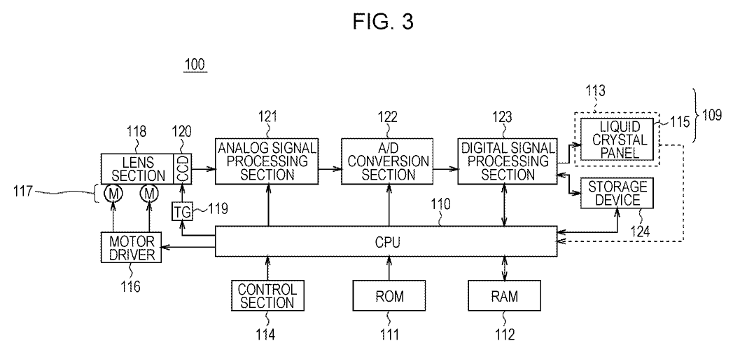

Next, a hardware configuration of the DSC 100 is described with reference to FIG. 3. In the DSC 100, a CPU 110 executes various kinds of processing by executing the loading of programs, which are stored in a ROM 111, to a RAM 112 and executing the programs, and controls each section in response to signals from a touch panel 113 and an operation section 114. In addition, the CPU is an abbreviation of Central Processing Unit. Further, the ROM is an abbreviation of Read Only Memory, and the RAM is an abbreviation of Random Access Memory.

The touch panel 113 is a device constituting the above-mentioned touch screen 109 together with the liquid crystal panel 115. In addition, when a certain position on the touch panel 113 is touched by a finger, the touch panel 113 detects the coordinates of the touched position (that is, the touch position). Then, the touch panel 113 transmits an input signal representing the coordinates of the touch position to the CPU 110.

When receiving the coordinates of the touch position from the input signal transmitted from the touch panel 113, the CPU 110 changes the coordinates into coordinates on a screen of the liquid crystal panel 115, thereby recognizing which position is touched on the screen of the liquid crystal panel 115.

Further, the CPU 110 sequentially changes the coordinates of the touch position, which is acquired from the input signals transmitted for each regular time, into the screen coordinates of the liquid crystal panel 115, thereby recognizing how the touch position moves (that is, the trace of the touch position).

Then, on the basis of the touch position and the trace thereof recognized as described above, the CPU 110 determines which touch operation is performed on which position on the screen.

The operation section 114 is a device including the shutter button 106, the playback button 107, the power button 108, and the like mentioned above, and transmits the signals corresponding to the operation mentioned above to the CPU 110.

On the basis of the signals transmitted from the operation section 114, the CPU 110 determines which one of the shutter button 106, the playback button 107, and the power button 108 is operated.

In practice, the CPU 110 is operated in the photography mode when being turned on by pressing the power button 108 of the operation section 114, or when receiving instruction to change the operation mode to the photography mode in accordance with the touch operation performed on the touch panel 113.

At this time, the CPU 110 controls a motor driver 116 to drive an actuator 117, thereby exposing a lens section 118, which includes the photographic lens 102, the AF illuminator 103, and the like, from the casing 101 of the DSC 100. Further, the CPU 110 drives the actuator 117 so as to adjust an aperture diaphragm of the lens section 118, change a zoom ratio of an optical zoom, or move a focus lens.

Further, at this time, the CPU 110 controls the timing generator 119 to supply a timing signal to an image pickup device 120 including the CCD (Charge Coupled Device) and the like. The image pickup device 120 converts light, which is originated from a subject and is received through the lens section 118, into an electric signal (that is, photoelectric conversion) by being operated on the basis of the timing signal, and transmits the signal to the analog signal processing section 121.

Under the control of the CPU 110, the analog signal processing section 121 obtains an analog image signal by performing analog signal processing (amplification and the like) on the electric signal, and transmits the signal to the analog digital conversion section (referred to as an A/D conversion section) 122.

Under the control of the CPU 110, the A/D conversion section 122 obtains a digital image signal by performing the analog digital conversion (the A/D conversion) on the received analog image signal, and transmits the signal to the digital signal processing section 123.

Under the control of the CPU 110, the digital signal processing section 123 performs a digital signal processing (noise removal and the like) on the received digital image signal, and then transmits it to the liquid crystal panel 115. As a result, the image of the subject is displayed as a monitoring image on the liquid crystal panel 115. In such a manner, the DSC 100 is configured to make a photographer confirm the subject.

Further, at this time, under the control of the CPU 110, the digital signal processing section 123 generates a signal of graphics such as characters and icons, and superimposes the graphic signal on the digital image signal. As a result, the characters, the icons, and the like are displayed together with the monitoring image on the liquid crystal panel 115.

Further, here, the shutter button 106 of the operation section 114 may be pressed down. In this case, the CPU 110 stores the image in accordance with the operation.

At this time, under the control of the CPU 110, the digital signal processing section 123 compresses the digital image signal received from the A/D conversion section 122 in a compression and decompression format such as JPEG, and thereby generates compressed image data. In addition, JPEG is an abbreviation of Joint Photographic Experts Group.

Further, at this time, under the control of the CPU 110, the digital signal processing section 123 generates data (referred to as thumbnail image data) of a thumbnail image which is obtained by scaling down the image based on the corresponding digital image signal. Then, the digital signal processing section 123 transmits the generated compressed image data and thumbnail image data to the CPU 110.

Further, at this time, the CPU 110 obtains the current time and date (that is, shooting time and date) from a timekeeper section (not shown in the drawings) such as a timer.

Then, the CPU 110 generates an image file by adding the thumbnail image data, the shooting time and date, and the like as metadata to the compressed image data, and stores the image file in the storage device 124. In such a manner, the CPU 110 stores images.

In addition, the storage device 124 is, for example, a non-volatile memory of about several gigabytes to several tens of gigabytes, may be a recording medium previously built in the DSC 100, and may be a recording medium, such as a memory card, detachable from the DSC 100.

On the other hand, when the playback button 108 of the operation section 114 is pressed down, or when instruction to change the operation mode to the playback mode is received by the touch operation performed on the touch panel 113, the CPU 110 is operated in the playback mode.

The playback modes of the DSC 100 include a single display mode that displays images one by one and an index display mode that displays a plurality of images as a list. The CPU 110 is operated, for example, in the single display mode immediately after changing the operation mode to the playback mode.

At this time, the CPU 110 generates data (referred to as single display configuration data) to configure a display screen (referred to as a single display screen) in the single display mode.

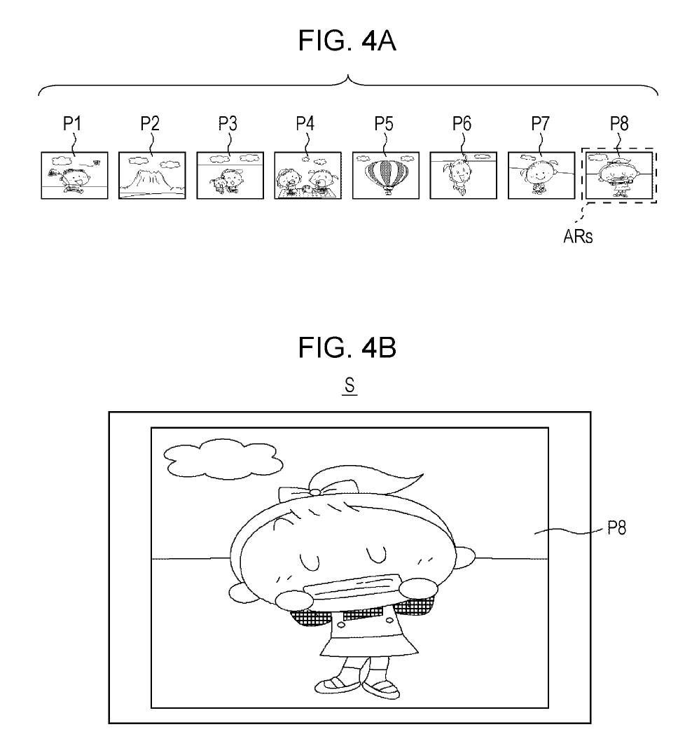

Specifically, the CPU 110 sets, as a display group, for example, the images, which have a shooting date designated through the touch panel 113, among, for example, the images stored in the storage device 124. Then, as shown in FIG. 4A, the CPU 110 sets arrangement of the plurality of images P (P1 to P8) included in the corresponding display group. For example, the images are arranged in an order that the shooting time of the image is more recent as it is closer to the right side than the left side. The CPU 110 generates the data, which represents the setting of the arrangement of the images P, as the single display configuration data.

Then, the CPU 110 sets an area (a display area) ARs, in which the arrangement of the images P is displayed as the single display screen, on the basis of a focus image. Specifically, the CPU 110 selects, as the focus image, for example, the image P8 of the most recent shooting time among the images P included in the display group, and sets the display area ARs including only the image P8.

Then, the CPU 110 reads out the image file corresponding to the image P8, which is included in the display area ARs, from the storage device 124, extracts the compressed image data from the image file, and transmits the data to the digital signal processing section 123.

Under the control of the CPU 110, the digital signal processing section 123 obtains the digital image signal, which is not compressed, by decompressing the received compressed image data. Then, under the control of the CPU 110, the digital signal processing section 123 generates the screen display signal for the single display screen on the basis of the corresponding digital image signal, and transmits the signal to the liquid crystal panel 115. As a result, as shown in FIG. 4B, the single display screen S, which shows the image P8, is displayed on the liquid crystal panel 115.

Here, a flick operation in the left direction may be performed on the touch panel 113. The flick operation is defined as an operation which flicks off the touch panel 113 with a user's finger (or pen or the like). In this case, the CPU 110 scrolls the images P so as to move them from the left side to the right side on the single display screen S by moving the display area ARs in the left direction in the set arrangement of the images P.

On the other hand, a flick operation in the right direction may be performed on the touch panel 113. In this case, the CPU 110 scrolls the images P so as to move them from the right to the left by moving the display area ARs in the right direction in the set arrangement of the images P.

Further, here, when receiving the instruction to change the operation mode to the index display mode through the touch panel 113, the CPU 110 is operated in the index display mode.

At this time, the CPU 110 generates data (referred to as index display configuration data) to configure a display screen (referred to as an index display screen) in the index display mode.

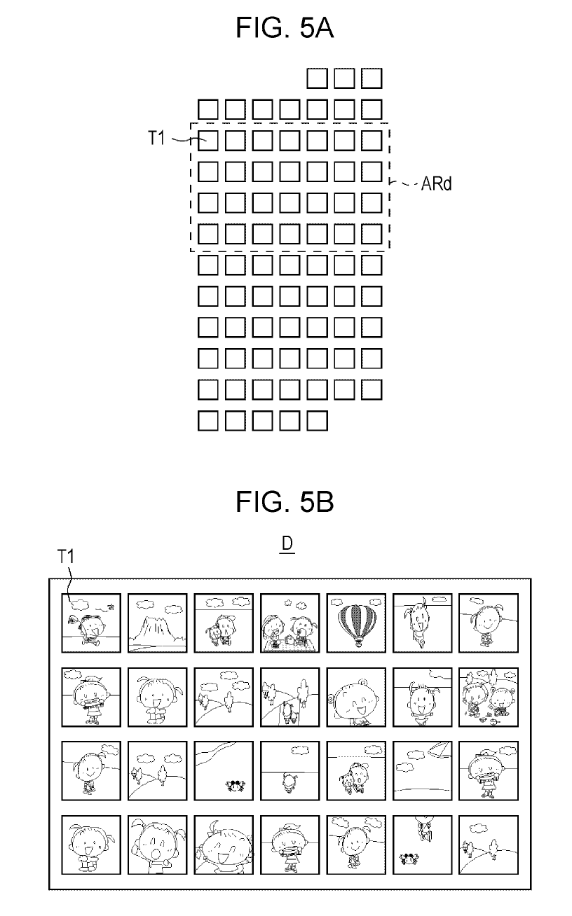

Specifically, the CPU 110 sets, as a display group, for example all the images stored in the storage device 124. Then, as shown in FIG. 5A, the CPU 110 sets arrangement of the respective thumbnail images T (T1 to Tn) of the images P included in the corresponding display group. For example, the thumbnail images are arranged in a matrix of K rows and 7 columns in an order that the shooting time and date of the image is more recent as it is closer to the right lower side than the left upper side. The CPU 110 generates data, which represents the setting of arrangement of the thumbnail images T, as the index display configuration data.

Moreover, the CPU 110 sets, for example, the thumbnail image T1 of the image P, which was being displayed on the liquid crystal panel 115 in the single display mode a moment ago, as the focus image. The CPU 110 sets the arrangement of the thumbnail images T so that the thumbnail image T1 as the focus image is positioned at the column of the left end.

Then, the CPU 110 sets an area (that is, the display area) ARd, in which the arrangement of the thumbnail images T is displayed as the index display screen, on the basis of the focus image. Specifically, the CPU 110 sets the display area ARd so that the thumbnail image T1 as the focus image is positioned at the top left end.

Moreover, in the DSC 100, the display area ARd is formed in a rectangular shape including the thumbnail images T corresponding to, for example, 4 rows and 7 columns (that is, 28 images).

Then, the CPU 110 reads out the image files corresponding to the respective thumbnail images T, which are included in the display area ARd, from the storage device 124, extracts the thumbnail image data from the image files, and transmits the data to the digital signal processing section 123.

Under the control of the CPU 110, the digital signal processing section 123 generates the screen display signal for the index display screen on the basis of the received thumbnail image data, and transmits the signal to the liquid crystal panel 115. As a result, as shown in FIG. 5B, the index display screen D, in which the thumbnail images T are arranged in a matrix, is displayed on the liquid crystal panel 115.

Here, a flick operation in the upward direction may be performed on the touch panel 113. In this case, the CPU 110 scrolls the thumbnail images T so as to move them from the upper side to the lower side by moving the display area ARd in the upward direction in the set arrangement of the thumbnail images T.

On the other hand, a flick operation in the downward direction may be performed on the touch panel 113. At this time, the CPU 110 scrolls the thumbnail images T so as to move them from the lower side to the upper side on the index display screen D by moving the display area ARd in the downward direction in the set arrangement of the thumbnail images T.

Further, in the single display mode and the index display mode, under the control of the CPU 110, the digital signal processing section 123 generates a signal of graphics such as characters and icons, and superimposes the graphic signal on the screen display signal. As a result, the characters, the icons, and the like are displayed together with the image P or the thumbnail images T on the liquid crystal panel 115.

Furthermore, the liquid crystal panel 115 of the DSC 100 is a hardware corresponding to the display section 2 of the above-mentioned display apparatus 1. Further, the touch panel 113 of the DSC 100 is a hardware corresponding to the input section 3 of the above-mentioned display apparatus 1. Furthermore, the CPU 110 of the DSC 100 is a hardware corresponding to the control section 4 of the above-mentioned display apparatus 1.

### 1-4. Scroll Processing in Index Display Mode

However, as described above, the DSC 100 is configured to be able to scroll the thumbnail images T in the up and downward direction of the screen by performing the flick operation on the touch panel 113 in the index display mode.

Hereinafter, the processing of scrolling the thumbnail images T in the index display mode will be described in detail. Furthermore, here, the flick operation, which corresponds to the scrolling, performed on the touch panel 113 is referred to as a scroll operation.

When the operation mode is changed to the index display mode, the CPU 110 sets the arrangement of the thumbnail images T included in the display group as described above, and sets the display area ARd on the arrangement. Then, the CPU 110 displays the index display screen D, which corresponds to the corresponding display area ARd, on the liquid crystal panel 115.

As described above, the size of the display area ARd corresponds to the 28 thumbnail images T, and maximally 28 thumbnail images T can be displayed on the liquid crystal panel 115. The number of the thumbnail images T, which can be displayed on the display screen of the liquid crystal panel 115, is referred to as a displayable number (here, 28).

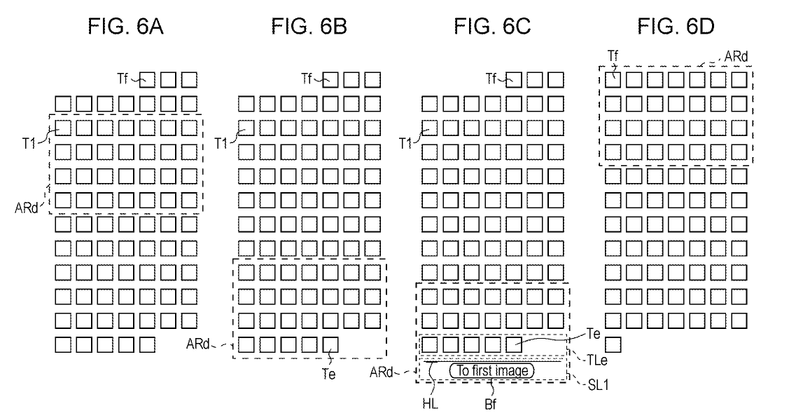

First, as shown in FIG. 6A, description is given of the case where the number of the thumbnail images T included in the display group is larger than the displayable number.

When the scroll operation is performed in the downward direction, the CPU 110 moves the display area ARd in the downward direction in the arrangement of the thumbnail images T which are set in accordance with the corresponding scroll operation as described above. In such a manner, the thumbnail images T are scrolled to be moved from the lower side to the upper side on the index display screen D.

Here, the CPU 110 may move the display area ARd up to the bottom of the set arrangement of the thumbnail images T in accordance with the scroll operation in the downward direction as shown in FIG. 6B. In this case, the thumbnail image (referred to as a last thumbnail image) Te at the last end of the display group is displayed on the liquid crystal panel 115. Moreover, the thumbnail images T may be arranged in the order that the shooting time and date of the image are more recent as it is closer to the right lower side than the left upper side. Thus, the last thumbnail image Te is the thumbnail image of the image, of which the shooting time and date are most recent, among the images included in the display group.

Here, when the scroll operation is further performed in the downward direction, the CPU 110 further scrolls the thumbnail images T from the lower side to the upper side by further moving the display area ARd in the downward direction. As a result, as shown in FIG. 6C, a blank line SL1 appears on the lower side of the row (that is, the end line) TLe including the last thumbnail image Te.

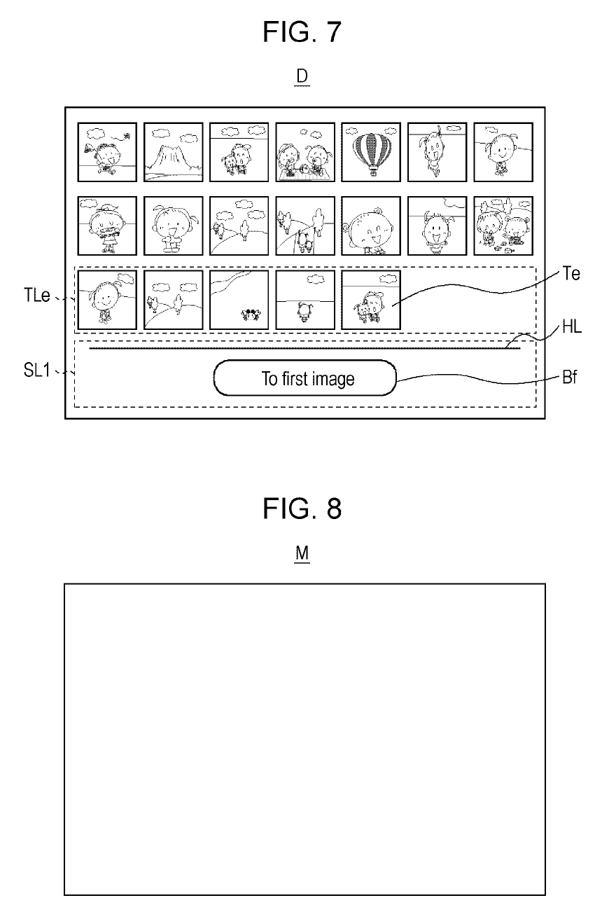

In this case, the CPU 110 displays a border line HL formed as one line extended in the left and right direction in the vicinity of the upper end of the blank line SL1, and displays the move-to-first button Bf on the lower side of the border line HL. That is, as shown in FIG. 7, the CPU 110 displays the index display screen D, which shows the border line HL and move-to-first button Bf in the blank line SL1 below the end line TLe, on the liquid crystal panel 115.

In the move-to-first button Bf, characters to the effect of “To first image” are shown. This means that it is possible to change the display of the liquid crystal panel 115 from the end line TLe to the first line TLf by performing the tap operation on the move-to-first button Bf through the touch panel 113. Furthermore, the tap operation is defined as an operation that touches the touch panel 113 with a finger and immediately separates the finger therefrom.

The processing, which is executed when the tap operation is performed on the move-to-first button Bf, is described in detail. When the corresponding tap operation is performed, the CPU 110 detects that the move-to-first button Bf is selected, and hides the index display screen D first. Then, as shown in FIG. 8, the CPU 110 displays a mute screen M as a screen on which the images, the characters, and the like are not displayed.

Further, at this time, the CPU 110 sets the thumbnail image (referred to as a first thumbnail image) Tf at the first position in the display group as the focus image. Furthermore, the first thumbnail image Tf is the thumbnail image of the image, of which the shooting time and date are oldest, among the images included in the display group.

Then, the CPU 110 changes, as shown in FIG. 6D, the arrangement of the thumbnail images T so that the first thumbnail image Tf as the focus image is positioned at the column of the left end.

After performing the processing, the CPU 110 moves, as shown in FIG. 6D, the display area ARd to the top of the arrangement of the thumbnail images T. Then, the CPU 110 hides the mute screen M, and displays the index display screen D, which corresponds to the corresponding display area ARd, on the liquid crystal panel 115. Consequently, the CPU 110 displays the first thumbnail image Tf on the liquid crystal panel 115.

Furthermore, when moving the display area ARd to the top in accordance with not the tap operation performed on the move-to-first button Bf but the scroll operation, the CPU 110 does not change the arrangement of the thumbnail images T.

As described above, in the DSC 100, when the last thumbnail image Te is displayed, the scroll operation may be performed in the downward direction. In this case, the border line HL and the move-to-first button Bf are displayed.

Thereby, the DSC 100 is able to make a user recognize that the displayed last thumbnail image Te is the last thumbnail image. Thus, it is possible to make the user distinctively recognize the last thumbnail image Te and the other thumbnail images T.

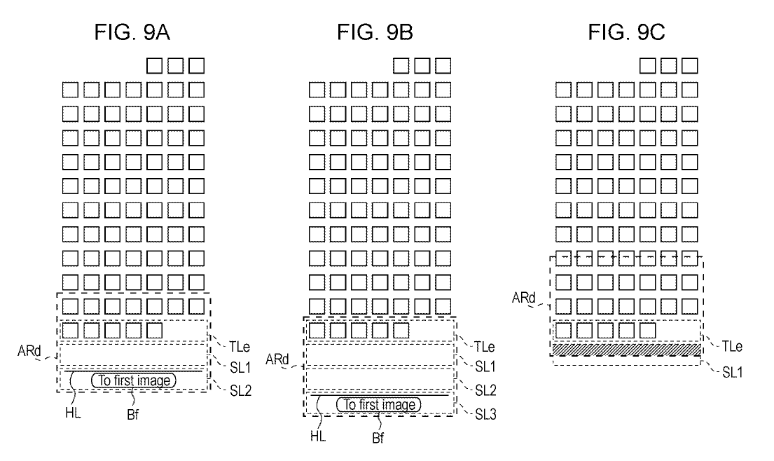

Further, as shown in FIG. 6C, while the move-to-first button Bf is displayed, the scroll operation in the downward direction may be further performed. In this case, as shown in FIG. 9A, the CPU 110 moves the display area ARd in the downward direction in the set arrangement of the thumbnail images T. As a result, a blank line SL2 appears on the lower side of the blank line SL1. At this time, the CPU 110 continuously displays the border line HL and the move-to-first button Bf in the blank line SL2.

As described above, while the move-to-first button Bf is displayed, the scroll operation may be performed in the downward direction. In this case, the CPU 110 further moves the display area ARd in the downward direction in accordance with the corresponding scroll operation. At this time, the CPU 110 continuously displays the border line HL and the move-to-first button Bf in the blank line SL which is at the bottom of the index display screen D.

As a result of the scroll operation which is further performed in the downward direction, as shown in FIG. 9B, the display area ARd includes only the end line TLe, that is, the liquid crystal panel 115 displays only the end line TLe, the border line HL, and the move-to-first button Bf.

In this condition, when the scroll operation is performed in the downward direction, the CPU 110 may move the display area ARd in the downward direction. In this case, the liquid crystal panel 115 does not display even one line of the thumbnail images T. Therefore, in this case, the CPU 110 does not move the display area ARd in the downward direction even when the scroll operation is performed in the downward direction.

Further, when the scroll operation is performed in the upward direction in a state where the move-to-first button Bf is displayed, the CPU 110 moves the display area ARd in the upward direction in the set arrangement of the thumbnail images T in accordance with the corresponding scroll operation. As a result, the thumbnail images T are scrolled from the upper side to the lower side. At this time, the CPU 110 continuously displays the border line HL and the move-to-first button Bf in the blank line SL which is at the bottom of the index display screen D.

As a result of the scroll operation which is further performed in the upward direction, for example as shown in FIG. 9C, the area (the hatched area in FIG. 9C) included in the display area ARd may be equal to or less than a half of the area of the blank line SL1 just below the end line TLe. That is, the hidden area of the blank line SL1, in which the move-to-first button Bf is being shown, may be equal to or more than the half thereof.

At this time, the CPU 110 determines that a user does not intend to use the move-to-first button Bf, and hides the border line HL and the move-to-first button Bf.

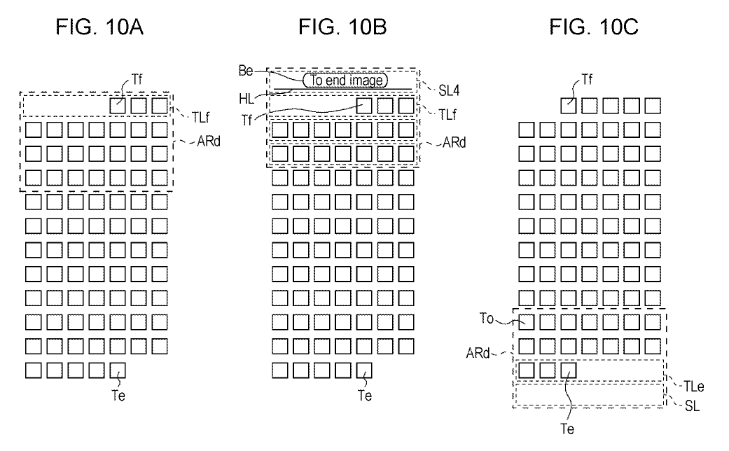

Further, the CPU 110 may move the display area ARd to the top of the set arrangement of the thumbnail images T in accordance with the scroll operation performed in the upward direction as shown in FIG. 10A. In this case, the first thumbnail image Tf is displayed on the liquid crystal panel 115.

Here, when the scroll operation is further performed in the upward direction, the CPU 110 further scrolls the thumbnail images T from the lower side to the upper side by further moving the display area ARd in the upward direction. As a result, as shown in FIG. 10B, a blank line SL4 appears on the upper side of the row (that is, the first line) TLf including the first thumbnail image Tf.

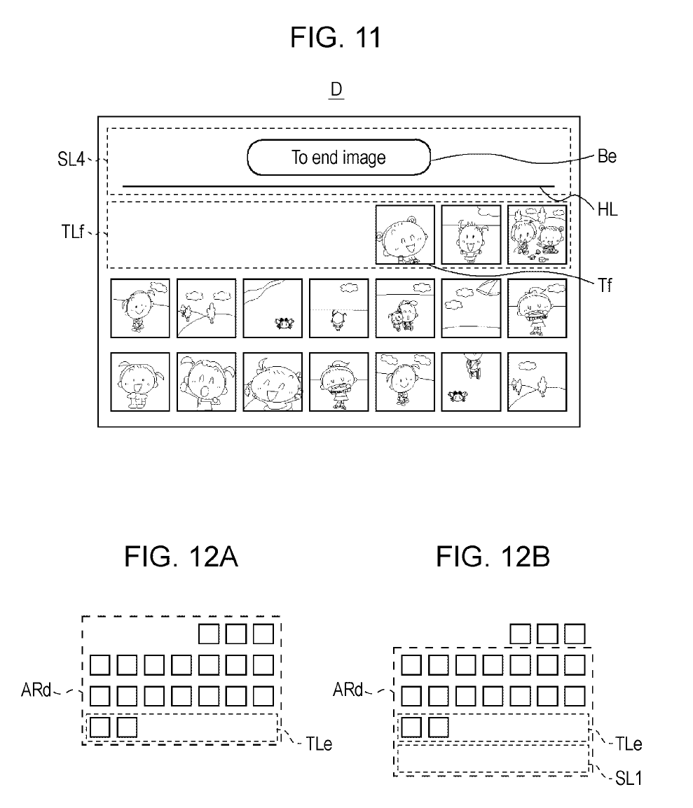

At this time, the CPU 110 displays the border line HL in the vicinity of the lower end of the blank line SL4, and displays the move-to-last button Be on the upper side of the border line HL. That is, as shown in FIG. 11, the CPU 110 displays the index display screen D, which shows the border line HL and the move-to-last button Be in the blank line SL4 above the first line TLf, on the liquid crystal panel 115.

At this time, the CPU 110 displays characters to the effect of “To end image” in the move-to-last button Be. This means that it is possible to change the display of the liquid crystal panel 115 from the first line TLf to the end line TLe by performing the tap operation on the move-to-last button Be.

The processing, which is executed when the tap operation is performed on the move-to-last button Be, is described in detail. When the corresponding tap operation is performed, the CPU 110 detects that the move-to-last button Be is selected, and hides the index display screen D first. Then, the CPU 110 displays the mute screen M (FIG. 8)

Further, at this time, the CPU 110 sets the last thumbnail image Te as the focus image. Then, as shown in FIG. 10C, the CPU 110 changes the arrangement of the thumbnail images T so that the thumbnail image To, of which the shooting date is the same as the last thumbnail image Te as the focus image and the shooting time is oldest, is positioned at the column of the left end.

After performing the processing, the CPU 110 moves the display area ARd to the bottom of the arrangement of the thumbnail images T. Furthermore, at this time, the CPU 110 moves the display area ARd so that the thumbnail image To is positioned at the top left end.

Then, the CPU 110 hides the mute screen M, and displays the index display screen D, which corresponds to the corresponding display area ARd, on the liquid crystal panel 115. Consequently, the CPU 110 displays the last thumbnail image Te on the liquid crystal panel 115.

Furthermore, when moving the display area ARd to the bottom in accordance with not the tap operation performed on the move-to-last button Be but the scroll operation, the CPU 110 does not change the arrangement of the thumbnail images T.

As described above, in the DSC 100, when the first thumbnail image Tf is displayed, the scroll operation may be performed in the upward direction. In this case, the border line HL and the move-to-last button Be are displayed.

Thereby, the DSC 100 is able to make a user recognize that the displayed first thumbnail image Tf is the first thumbnail image. Thus, it is possible to make the user distinctively recognize the first thumbnail image Tf and the other thumbnail images T.

Further, as shown in FIG. 10B, while the move-to-last button Be is displayed, the scroll operation in the upward direction may be further performed. In this case, the CPU 110 moves the display area ARd in the upward direction in the set arrangement of the thumbnail images T. At this time, the CPU 110 continuously displays the border line HL and the move-to-last button Be in the blank line SL which is at the top of the index display screen D.

As a result of the scroll operation which is further performed in the upward direction, the display area ARd includes only the first line TLf. In this case, the CPU 110 does not move the display area ARd in the upward direction even when the scroll operation is further performed in the upward direction.

Further, when the scroll operation is performed in the downward direction in a state where the move-to-last button Be is displayed, the CPU 110 moves the display area ARd in the downward direction in the set arrangement of the thumbnail images T in accordance with the corresponding scroll operation. At this time, the CPU 110 displays the above-mentioned border line HL and move-to-last button Be in the blank line SL which is at the top of the index display screen D.

As a result of the scroll operation which is further performed in the downward direction, for example, the area included in the display area ARd may be equal to or less than a half of the area of the blank line SL4 just above the first line TLf of the thumbnail images T. That is, the hidden area of the blank line SL4, in which the move-to-last button Be is being shown, may be equal to or more than the half thereof.

At this time, the CPU 110 determines that a user does not intend to use the move-to-last button Be, and hides the border line HL and the move-to-last button Be.

Next, as shown in FIG. 12A, description is given of the case where the number of thumbnail images T included in the display group is equal to or less than the displayable number (here, 28).

The CPU 110 moves the display area ARd to the bottom of the set arrangement of the thumbnail images T in accordance with the scroll operation performed in the downward direction. At this time, when the scroll operation is further performed in the downward direction, the CPU 110 further moves the display area ARd in the downward direction, thereby further scrolling the thumbnail images T from the lower side to the upper side. As a result, as shown in FIG. 12B, the blank line SL appears on the lower side of the end line TLe.

Contrary to the case where the number of thumbnail images T included in the above-mentioned display group is larger than the displayable number, here the CPU 110 does not display the move-to-first button Bf and the border line HL in the blank line SL.

Further, when the scroll operation is further performed in the upward direction in a state where the display area ARd is at the top of the set arrangement of the thumbnail images T, the CPU 110 further moves the display area ARd in the upward direction. As a result, the blank line SL appears on the upper side of the first line TLf.

At this time, contrary to the case where the number of thumbnail images T included in the above-mentioned display group is larger than the displayable number, the CPU 110 does not display the move-to-last button Be and the border line HL in the blank line SL.

In the case where the number of thumbnail images T is less than the displayable number, if only the thumbnail images T corresponding to at least one line is scrolled, the CPU 110 is able to make a user confirm the first thumbnail image T and the last thumbnail image Te. Therefore, in this case, the CPU 110 does not display the move-to-first button Bf and the move-to-last button Be.

### 1-5. Procedure of Scroll Processing in Index Display Mode

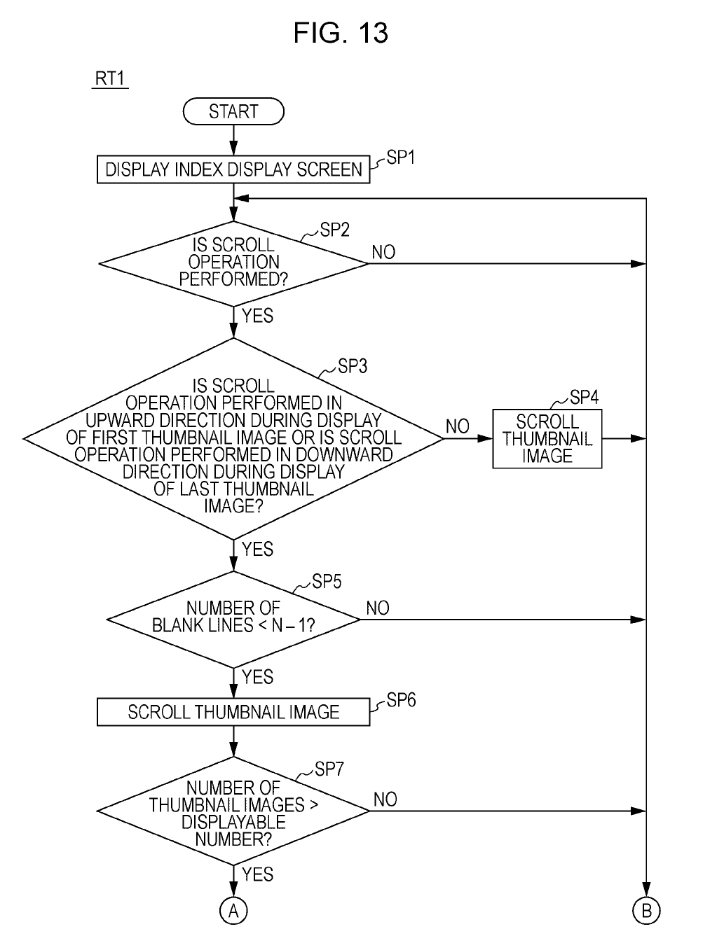

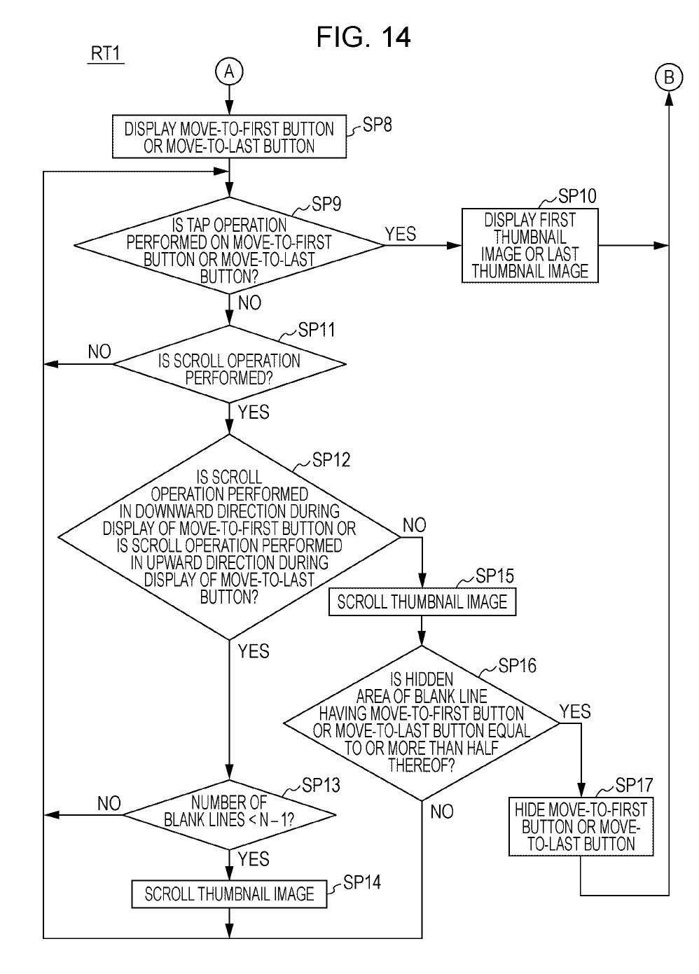

As described above, the DSC 100 is configured to scroll the thumbnail images T in accordance with the scroll operation in the index display mode. Hereinafter, the operation processing procedure of the scroll processing in the index display mode (referred to as an index scroll processing order) is described with reference to the flowchart shown in FIGS. 13 and 14.

In addition, the index scroll processing order RT1 is a processing order which is executed by the CPU 110 of the DSC 100 in accordance with the programs stored in the ROM 111.

When the index display mode is selected through the touch panel 113, the CPU 110 starts the index scroll processing order RT1, and advances to step SP1.

In step SP1, the CPU 110 sets the arrangement of the thumbnail images T included in the display group as described above, and sets the display area ARd on the arrangement. Then, the CPU 110 displays the index display screen D, which corresponds to the corresponding display area ARd, on the liquid crystal panel 115, and advances to the next step SP2.

In step SP2, the CPU 110 determines whether or not the scroll operation is performed through the touch panel 113.

If there is a negative result that the scroll operation is not performed in step SP2, the CPU 110 returns to step SP2 again, and is on standby until the scroll operation is performed.

In contrast, if there is a positive result that the scroll operation is performed in step SP2, at this time, the CPU 110 advances to the next step SP3.

In step SP3, the CPU 110 determines whether or not the performed scroll operation is the scroll operation which is performed in the upward direction while the first thumbnail image Tf is displayed, or determines whether or not the performed scroll operation is the scroll operation which is performed in the downward direction while the last thumbnail image Te is displayed.

If there is a negative result that the performed scroll operation does not correspond to anything in step SP3, the CPU 110 advances to the next step SP4.

In step SP4, the CPU 110 scrolls the thumbnail images T by moving the display area ARd in the set arrangement of the thumbnail images T in accordance with the performed scroll operation, and returns to step SP2 again.

In contrast, if there is a positive result in step SP3, at this time, the CPU 110 advances to the next step SP5.

In step SP5, the CPU 110 determines whether or not the number of the blank lines SL included in the display area ARd is less than the number which is obtained by subtracting 1 from the maximum number of lines N (here, 4) included in the display area ARd. That is, the CPU 110 determines whether or not the thumbnail images T are displayed in the range of two or more lines on the liquid crystal panel 115.

If there is a negative result in step SP5, this means that the thumbnail images T are displayed by only one line on the liquid crystal panel 115. In this case, the CPU 110 does not move the display area ARd (that is, does not scroll the thumbnail images T), and returns to step SP2.

In contrast, if there is a positive result in step SP5, this means that the thumbnail images T are displayed in the range of two or more lines on the liquid crystal panel 115, and in this case, the CPU 110 advances to the next step SP6.

In step SP6, the CPU 110 scrolls the thumbnail images T by moving the display area ARd in the set arrangement of the thumbnail images T in accordance with the scroll operation, and advances to the next step SP7.

In step SP7, the CPU 110 determines whether or not the number of thumbnail images T included in the display group is more than the displayable number.

If there is a negative result that the number of thumbnail images T included in the display group is equal to or less than the displayable number in step SP7, at this time, the CPU 110 does not display the move-to-first button Bf or the move-to-last button Be, and returns to step SP2.

In contrast, if there is a positive result that the number of thumbnail images T included in the display group is more than the displayable number in step SP7, at this time, the CPU 110 advances to the next step SP8 (FIG. 14).

In step SP8, when the performed scroll operation is the scroll operation which is performed in the upward direction during display of the first thumbnail image Tf, the CPU 110 displays the move-to-last button Be in the top blank line SL.

In contrast, when the performed scroll operation is the scroll operation which is performed in the downward direction during display of the last thumbnail image Te, the CPU 110 displays the move-to-first button Bf in the last blank line SL.

As described above, the CPU 110 displays the move-to-first button Bf or the move-to-last button Be, and advances to the next step SP9.

In step SP9, the CPU 110 determines whether or not the tap operation is performed on the move-to-first button Bf or the move-to-last button Be.

If there is a positive result that the tap operation is performed on the move-to-first button Bf or the move-to-last button Be in step SP9, the CPU 110 advances to the next step SP10.

In step SP10, when the performed operation is the tap operation which is performed on the move-to-first button Bf, the CPU 110 displays the first thumbnail image Tf on the liquid crystal panel 115 by moving the display area ARd to the top of the arrangement of the thumbnail images T.

In contrast, when the performed operation is the tap operation which is performed on the move-to-last button Be, the CPU 110 displays the last thumbnail image Te on the liquid crystal panel 115 by moving the display area ARd to the bottom of the arrangement of the thumbnail images T.

As described, the CPU 110 displays the first thumbnail image Tf or the last thumbnail image Te in accordance with the tap operation performed on the move-to-first button Bf or the move-to-last button Be, and returns to step SP2.

In contrast, if there is a negative result that the tap operation is not performed on the move-to-first button Bf or the move-to-last button Be in step SP9, the CPU 110 advances to the next step SP11.

In step SP11, the CPU 110 determines whether or not the scroll operation is performed through the touch panel 113.

If there is a negative result that the scroll operation is not performed in step SP11, the CPU 110 returns to step SP9, and determines whether or not the tap operation is performed on the move-to-first button Bf or the move-to-last button Be. That is, the CPU 110 repeats step SP9 and step SP11 until the scroll operation is performed or the tap operation is performed on the move-to-first button Bf or the move-to-last button Be.

In contrast, if there is a positive result that the scroll operation is performed in step SP11, the CPU 110 advances to the next step SP12.

In step SP12, the CPU 110 determines whether or not the corresponding scroll operation is the scroll operation which is performed in the downward direction while the move-to-first button Bf is displayed, or determines whether or not the corresponding scroll operation is the scroll operation which is performed in the upward direction while the move-to-last button Be is displayed.

If there is a positive result that the performed scroll operation corresponds to any of the scroll operation in step SP12, the CPU 110 advances to the next step SP13.

In step SP13, the CPU 110 determines whether or not the number of the blank lines SL included in the display area ARd is less than the number which is obtained by subtracting 1 from the maximum number of lines N included in the display area ARd.

If there is a negative result in step SP13, this means that the thumbnail images T are displayed by only one line on the liquid crystal panel 115. In this case, the CPU 110 does not scroll the thumbnail images T, and returns to step SP9 again.

In contrast, if there is a positive result in step SP13, this means that the thumbnail images T are displayed in the range of two or more lines on the liquid crystal panel 115, and in this case, the CPU 110 advances to the next step SP14.

In step SP14, the CPU 110 scrolls the thumbnail images T by moving the display area ARd in the set arrangement of the thumbnail images T in accordance with the scroll operation, and returns to step SP9 again.

In contrast, if there is a negative result in step SP12, this means that the performed scroll operation is the scroll operation which is performed in the upward direction while the move-to-first button Bf is displayed, or is the scroll operation which is performed in the downward direction while the move-to-last button Be is displayed. In this case, the CPU 110 advances to the next step SP15.

In step SP15, the CPU 110 scrolls the thumbnail image T by moving the display area ARd in the arrangement of the thumbnail images T in accordance with the scroll operation, and advances to the next step SP16.

In step SP16, the CPU 110 determines whether or not the hidden area of the blank line SL, in which the move-to-first button Bf or the move-to-last button Be is being shown, is equal to or more than the half thereof.

If there is a negative result in step SP16, at this time, the CPU 110 returns to step SP9 in the state where the move-to-first button Bf or the move-to-last button Be is displayed.

In contrast, if there is a positive result in step SP16, this means that a user does not intend to use the move-to-first button Bf or the move-to-last button Be. In this case, the CPU 110 advances to the next step SP17.

In step SP17, the CPU 110 hides the move-to-first button Bf or the move-to-last button Be, and returns to step SP2 again.

According to the index scroll processing order RT1, the DSC 100 is configured to scroll the thumbnail images T in the index display mode.

### 1-6. Operations and Effects of Embodiment

In the DSC 100 having the above-mentioned configuration, the thumbnail images T of all the images, which are stored in the storage device 124, are set as the display group. Further, in the DSC 100, the arrangement of the thumbnail images T included in the display group is set so that the thumbnail images T are arranged in a matrix from the left upper side to the right lower side in the shooting time and date order. Furthermore, in the DSC 100, the display area ARd is set on the arrangement of the thumbnail images T, and the thumbnail images T included in the display area ARd are displayed on the liquid crystal panel 115.

In the DSC 100, when a user performs the scroll operation with the aid of the touch panel 113, the display area ARd is moved in accordance with the corresponding scroll operation, and thereby the thumbnail images T included in the display group are displayed in series (that is, scrolled).

In the DSC 100, when the scroll operation is performed in the upward direction while the first thumbnail image Tf is displayed, the move-to-last button Be is displayed. Further, in the DSC 100, when the scroll operation is performed in the downward direction while the last thumbnail image Te is displayed, the move-to-first button Bf is displayed.

That is, in the DSC 100, while the thumbnail image (the first thumbnail image Tf or the last thumbnail image Te) at one end of the display group is displayed, the information representing the thumbnail image T at one end is displayed.

With such a configuration, the DSC 100 is able to make a user recognize that the currently displayed thumbnail image T is the thumbnail image T at one end of the display group. Therefore, the DSC 100 is able to make a user distinctively recognize the thumbnail image T at one end and the other thumbnail images T, for example, even when looping and displaying the thumbnail images T included in the display group.

Further, thereby, the DSC 100 is able to make a user distinctively recognize the thumbnail image T at one end and the other thumbnail images T, for example, even when not displaying a scroll bar or the like. Therefore, in the DSC 100, the display area for the scroll bar is not necessary, and thus it is possible to widen the display area of the thumbnail images T to that extent. Therefore, it is possible to make the thumbnail images T quite visible or it is possible to increase the displayable number of thumbnail images T, and thus it is possible to improve visibility of the thumbnail images T as a list.

Further, as described above, in the DSC 100, while the thumbnail image T at one end of the display group is displayed, when the operation to display the next thumbnail image T is performed, the move-to-last button Be or the move-to-first button Bf is displayed.

Thereby, when a user is highly likely to operate the move-to-last button Be or the move-to-first button Bf, the DSC 100 is able to display the corresponding button. Therefore, otherwise, the display area for the corresponding button is not necessary, and thus the DSC 100 is able to widen the display area of the thumbnail images T to that extent. Therefore, it is possible to make the thumbnail images T quite visible, or it is possible to increase the displayable number of thumbnail images T.

In the DSC 100, when the tap operation is performed on the move-to-last button Be, the last thumbnail image Te is displayed. Further, in the DSC 100, when the tap operation is performed on the move-to-first button Bf, the first thumbnail image Tf is displayed.

Specifically, in the DSC 100, when an operation relating to the information, which represents the thumbnail image T at one end of the display group, is performed, the thumbnail image T at the other end of the corresponding display group is displayed.

With such a configuration, the DSC 100 makes a user recognize that the processing of changing the display of the thumbnail image T on the liquid crystal panel 115 from the one end to the other end (that is, from the first to the last or from the last to the first) is intended to be performed, and then the DSC 100 is able to perform the corresponding processing. Accordingly, the DSC 100 is able to prevent the corresponding processing from being performed when a user does not want the processing.

Hence, when it takes time to perform the corresponding processing, the DSC 100 makes a user recognize that the corresponding processing is performed, and is then able to perform the corresponding processing. Therefore, it is possible to prevent the processing, which takes time, from being performed when a user does not want the processing.

In the DSC 100, when the flick operation is performed on the touch panel 113, the thumbnail images T are scrolled. Further, in the DSC 100, when the tap operation is performed on the move-to-first button Bf or the move-to-last button Be, the display of the thumbnail image T on the liquid crystal panel 115 is changed from the last to the first or from the first to the last.

That is, in the DSC 100, the operation that scrolls the thumbnail images T is set to be different from the operation that changes the display of the thumbnail image T on the liquid crystal panel 115 from one end to the other end.

In such a manner, in the DSC 100, even though the thumbnail image T at one end is displayed when a user continuously performs the scroll operation, the processing, which changes the display of the thumbnail image T on the liquid crystal panel 115 from one end to the other end, is not performed. Therefore, the DSC 100 is able to prevent the corresponding processing from being performed when a user does not want the processing.

In the DSC 100, when the number of thumbnail images T included in the display group is equal to or less than the displayable number, the move-to-first button Bf and the move-to-last button Be are not displayed. That is, in the DSC 100, when the number of thumbnail images T included in the display group is more than a displayable number, the information representing the thumbnail image T at one end is displayed.

Thereby, in the DSC 100, when it is difficult to make a user distinctively recognize the thumbnail image T at one end and the other thumbnail images T, it is possible to display the information representing the thumbnail image T at one end. Therefore, otherwise, the display area for the corresponding information is not necessary, and thus the DSC 100 is able to widen the display area of the thumbnail images T to that extent. Therefore, it is possible to make the thumbnail images T quite visible, or it is possible to increase the displayable number of thumbnail images T.

In the DSC 100, when the tap operation is performed on the move-to-last button Be, the mute screen M is displayed by hiding the index display screen D. Then, in the DSC 100, after the processing of changing the display of the thumbnail image T on the liquid crystal panel 115 from the last to the first is terminated, the last thumbnail image Te is displayed.

On the other hand, in the DSC 100, when the tap operation is performed on the move-to-first button Bf, the mute screen M is displayed by hiding the index display screen D. Then, in the DSC 100, after the processing of changing the display of the thumbnail image T on the liquid crystal panel 115 from the first to the last is terminated, the first thumbnail image Tf is displayed.

As described above, in the DSC 100, when the operation relating to the information, which represents the thumbnail image T at one end, is performed, the predetermined screen is displayed by hiding the thumbnail image T at one end. Then, in the DSC 100, after the processing of changing the display of the thumbnail image T on the liquid crystal panel 115 from one end to the other end is terminated, the thumbnail image T at the other end is displayed.

With such a configuration, the DSC 100 is able to make a user more easily recognize that the display of the thumbnail image T on the liquid crystal panel 115 is changed from one end to the other end.

Further, thereby in the DSC 100, during the display of the mute screen M, it is possible to perform the processing of changing the display of the thumbnail image T on the liquid crystal panel 115 from one end to the other end. Therefore, in the DSC 100, it is possible to perform the corresponding processing without giving the impression of waiting for the termination of the corresponding processing to a user.

With such a configuration, in the DSC 100, when the first thumbnail image Tf or the last thumbnail image Te, which is the endmost thumbnail image T of the display group, is displayed, the move-to-last button Be or the move-to-first button Bf is displayed.

Thereby, the DSC 100 is able to make a user distinctively recognize the first thumbnail image Tf or the last thumbnail image Te and the other thumbnail images T. In such a manner, the DSC 100 is able to make a user distinctively recognize the endmost thumbnail image T thereof when displaying the thumbnail images T in series.

### 2. Other Embodiments

### 2-1. Another Embodiment 1

Moreover, in the DSC 100 according to the above-mentioned embodiment, while the first thumbnail image Tf or the last thumbnail image Te is displayed in the index display mode, the move-to-last button Be or the move-to-first button Bf is displayed.

However, the invention is not limited to this, and in the DSC 100, when the first image Pf or the last image Pe is displayed in the single display mode, the move-to-last button Be or the move-to-first button Bf may be displayed.

Specifically, when changing to the single display mode, the CPU 110 sets, as a display group, the image of the shooting date designated through the touch panel 113 as described above. Then, the CPU 110 sets arrangement of the image P included in the display group, and sets the display area ARs (FIG. 4) on the arrangement, thereby displaying the image P, which is included in the corresponding display area ARs, as the single display screen S on the liquid crystal panel 115.

Here, when the scroll operation is performed in the right direction, the CPU 110 moves the display area ARs in the right direction in the set arrangement of the image P in accordance with the corresponding scroll operation as described above. Thereby, the image P, which is displayed on the liquid crystal panel 115, is scrolled to be moved from the left side to the right side.

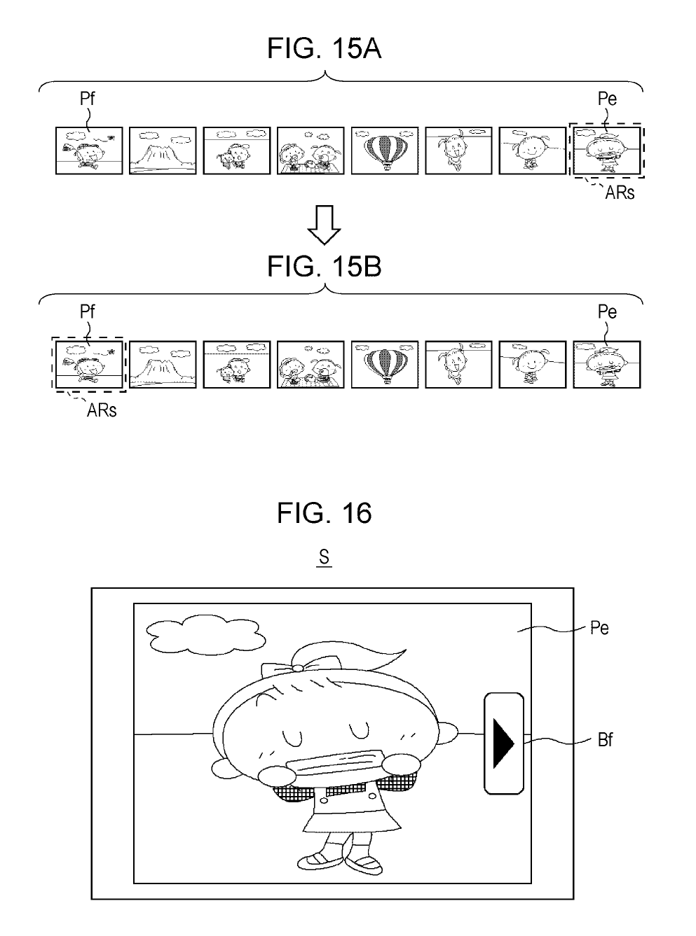

In this case, as shown in FIG. 15A, the CPU 110 may move the display area ARs to the leftmost side of the set arrangement of the image P in accordance with the scroll operation performed in the right direction. In this case, the image (referred to as the last image) Pe at the last position in the display group is displayed on the liquid crystal panel 115.

As described above, the images P are arranged in the shooting time order from the left side to the right side. Therefore, the last image Pe is the image of the most recent shooting time in the display group.

At this time, when the scroll operation is further performed in the right direction, the CPU 110 displays the move-to-first button Bf on the last image Pe as shown in FIG. 16. On the move-to-first button Bf, for example, the arrow in the right direction is displayed.

Then, when the tap operation is performed on the move-to-first button Bf, as shown in FIG. 15B, the CPU 110 moves the display area ARs to the leftmost side of the set arrangement of the images P, thereby displaying the first image Pf on the liquid crystal panel 115.

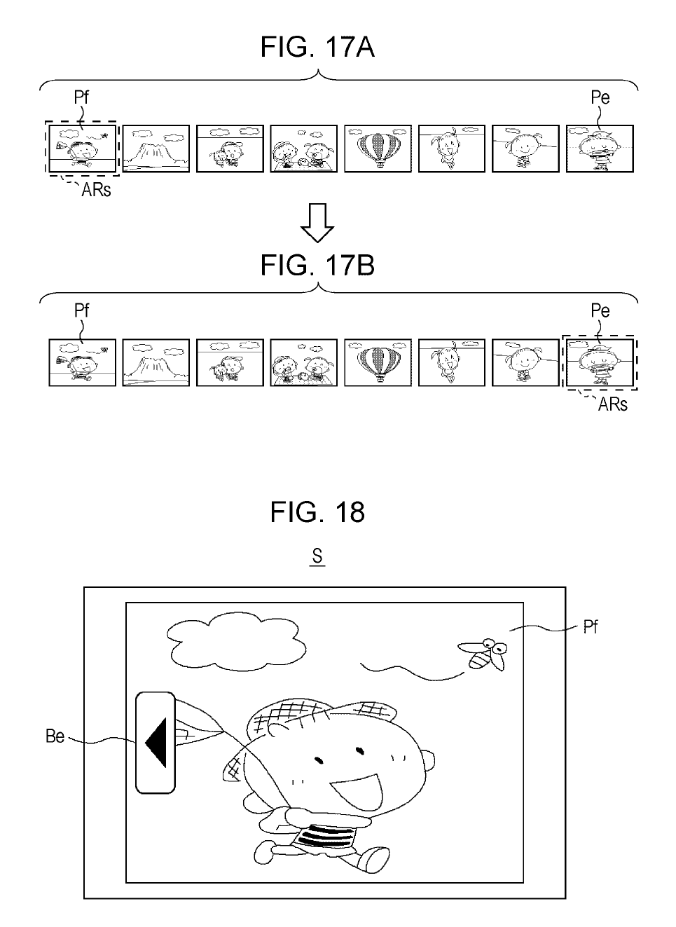

Further, when the first image Pf is displayed as described above, that is, when the display area ARs is positioned at the leftmost side of the set arrangement of the images P as shown in FIG. 17A, the scroll operation may be performed in the left direction.

In this case, the CPU 110 displays, as shown in FIG. 16, the move-to-last button Be on the first image Pf. On the move-to-last button Be, for example, the arrow in the left direction is displayed.

Then, when the tap operation is performed on the move-to-last button Be, as shown in FIG. 17B, the CPU 110 moves the display area ARs to the rightmost side of the set arrangement of the images P, thereby displaying the last image Pe on the liquid crystal panel 115.

As described above, in the DSC 100, while the endmost image P (the first image Pf or the last image Pe) in the display group is displayed, the operation to display the next image P may be performed. In this case, the move-to-last button Be or the move-to-first button Bf is displayed.

Thereby, the DSC 100 is able to make a user recognize that the currently displayed image P is the endmost image P in the display group. Thus, it is possible to make a user distinctively recognize the endmost image P and the other images P.

Further, when the move-to-last button Be or the move-to-first button Bf is displayed and subsequently the tap operation is not performed on the button within a predetermined time (for example, within 5 seconds), the CPU 110 hides the button.

In such a manner, the DSC 100 is able to make a user recognize the first image Pf or the last image Pe, and can be configured not to hide the first image Pf or the last image Pe by using the button. Therefore, the DSC 100 is able to make the first image Pf or last image Pe quite visible.

Further, when the number of the images P included in the display group is equal to or less than the predetermined number (for example, 2), the CPU 110 does not display the move-to-last button Be or the move-to-first button Bf.

Thereby, in the DSC 100, when it is difficult to make a user distinctively recognize the first image Pf and the last image Pe, it is possible to display the move-to-last button Be or the move-to-first button Bf. Therefore, otherwise the corresponding button is not displayed, and thus the DSC 100 can be configured not to hide the image P by using the corresponding button. Therefore, it is possible to make the image P quite visible.

Further, other than that, it can be regarded that the DSC 100 according to the embodiment 1 has the same effects as the DSC 100 according to the above-mentioned embodiment.

### 2-2. Another Embodiment 2

Further, in the above-mentioned embodiment, the CPU 110 sets the thumbnail images T of all the images, which are stored in the storage device 124, as the display group, and displays the thumbnail images T included in the corresponding display group in series.

However, the invention is not limited to this, and the CPU 110 may set various different predetermined groups (for example, shooting dates and folders) as the display groups.

In this case, when the endmost thumbnail image T in an optional display group is displayed, the CPU 110 may display the button to display an image, which is included in a group other than the corresponding display group, instead of the move-to-first button Bf or the like.

Specifically, the CPU 110 sets, for example, thumbnail images T of an optional shooting date as the display group, and displays the thumbnail images T included in the corresponding display group in series. Then, while the CPU 110 displays the last thumbnail image Te, the scroll operation may be performed in the downward direction. In this case, the CPU 110 displays a button (referred to as a move-to-next-group button) that moves the display to a group of which a shooting date is more recent than the corresponding shooting date.

Then, for example, when the tap operation is performed on the move-to-next-group button, the CPU 110 sets the thumbnail images T, of which the shooting date is more recent than the corresponding shooting date, as the display group. Then, the CPU 110 displays, for example, the first thumbnail image Tf of the corresponding group on the liquid crystal panel 115.

Further, while the CPU 110 displays the first thumbnail image Tf, the scroll operation may be performed in the upward direction. In this case, the CPU 110 displays a button (referred to as a move-to-previous-group button) that moves the display to a group of which a shooting date is older than the corresponding shooting date.

Then, for example, when the tap operation is performed on the move-to-previous-group button, the CPU 110 sets the thumbnail images T, of which the shooting date is older than the corresponding shooting date, as the display group. Then, the CPU 110 displays, for example, the last thumbnail image Te of the corresponding group on the liquid crystal panel 115.

As described above, while the CPU 110 displays the thumbnail image T at one end of the display group, the operation to display the next image may be performed. In this case, the CPU 110 displays the button to display the thumbnail images T included in a group other than the corresponding display group. In such a manner, the DSC 100 is able to make a user distinctively recognize the thumbnail image T at one end of the display group and the other thumbnail images T.

Further, other than that, it can be regarded that the DSC 100 according to the embodiment 2 has the same effects as the DSC 100 according to the above-mentioned embodiment.

### 2-3. Another Embodiment 3

In the above-mentioned embodiment, while displaying the first thumbnail image Tf or the last thumbnail image Te, the CPU 110 displays the move-to-last button Be or the move-to-first button Bf.

However, the invention is not limited to this, and the CPU 110 may display various information (for example, an icon, a message, and the like), which informs a user of the endmost thumbnail image T, instead of the move-to-last button Be or the move-to-first button Bf.

For example, while the CPU 110 displays the first thumbnail image Tf, the scroll operation may be performed in the upward direction. In this case, the CPU 110 may display, for example, a message to the effect that “The current image is the first. Do you want to move it to the last position?”.

Further, while the CPU 110 displays the corresponding message, the scroll operation may be further performed in the upward direction. In this case, the CPU 110 may move the display area ARd to the bottom so as to display the last thumbnail image Te. Further, while the CPU 110 displays the corresponding message, the scroll operation stronger than the normal scroll operation may be performed (for example, the flick operation of which the touch time is long may be performed). In this case, the CPU 110 may display the last thumbnail image Te.

Likewise, while the CPU 110 displays the last thumbnail image Te, the scroll operation may be performed in the downward direction. In this case, the CPU 110 may display, for example, a message to the effect that “The current image is the last. Do you want to move it to the first position?”. Then, while the CPU 110 displays the corresponding message, the scroll operation may be further performed in the downward direction. In this case, the CPU 110 may move the display area ARd to the top so as to display the first thumbnail image Tf.

Specifically, while the CPU 110 displays the thumbnail image T at one end of the display group, the operation (the scroll operation) to display the next thumbnail image T may be performed. In this case, the CPU 110 displays the information which represents the corresponding thumbnail image T at one end. Then, after the CPU 110 displays the corresponding information, the operation to display the next thumbnail image T may be performed. In this case, the CPU 110 may display the thumbnail image T at the other end of the corresponding display group.

### 2-4. Another Embodiment 4

In the above-mentioned embodiment, while displaying the first thumbnail image Tf or the last thumbnail image Te, the CPU 110 displays the move-to-last button Be or the move-to-first button Bf.

However, the invention is not limited to this, and the CPU 110 may display various different information (an icon and the like), which makes a user recognize the first image or the last image, instead of the move-to-last button Be or the move-to-first button Bf.

Further, the above description does not limit the shape, the size, the display position, and the like of the move-to-last button Be or the move-to-first button Bf, and the displayed button may have various different shapes, sizes, display positions, and the like.

### 2-5. Another Embodiment 5

In the above-mentioned embodiment, while displaying the last thumbnail image Te, the CPU 110 displays the move-to-first button Bf. Then, when the tap operation is performed on the move-to-first button Bf, the CPU 110 displays the first thumbnail image Tf.

However, the invention is not limited to this, and when the tap operation is performed on the move-to-first button Bf, the CPU 110 may display the first thumbnail image Tf and simultaneously display the move-to-last button Be.

The CPU 110 displays the last thumbnail image Tf until just before the tap operation is performed on the move-to-first button Bf. Therefore, it is conceivable that, after confirming the first thumbnail image Tf which is displayed by performing the tap operation on the move-to-first button Bf, a user may want to confirm the last thumbnail image Tf again.

In this case, the CPU 110 displays the first thumbnail image Tf and simultaneously displays the move-to-last button Be so as to make a user perform the tap operation on the move-to-last button Be. In such a manner, it is possible to display the last thumbnail image Te again.

Specifically, in the DSC 100, after the display of the thumbnail image T on the liquid crystal panel 115 is changed from the last to the first, if only a user performs a simple operation, it is possible to change the display of the thumbnail image T on the liquid crystal panel 115 from the first to the last.

Likewise, when the tap operation is performed on the move-to-last button Be, the CPU 110 may display the last thumbnail image Te and simultaneously display the move-to-first button Bf.

Specifically, the CPU 110 may display the thumbnail image T at the other end by performing the operation relating to the information which represents the thumbnail image T at one end of the display group. In this case, the CPU 110 may display the information which represents the thumbnail image T at the other end.

### 2-6. Another Embodiment 6

In the above-mentioned embodiment, when the tap operation is performed on the move-to-first button Bf or the move-to-last button Be, the CPU 110 inserts the mute screen M, and displays the first thumbnail image Tf or the last thumbnail image Te.

However, the invention is not limited to this, and the CPU 110 may display various different screens instead of the mute screen M. For example, the DSC 100 may display a screen that informs a user that the display of the liquid crystal panel 115 is moved to the first image or the last image. In this case, the DSC 100 displays, for example, a screen that shows a message (for example, a message to the effect that “The first image will be displayed” and the like) representing the image to be displayed next time.

### 2-7. Another Embodiment 7

In the above-mentioned embodiment, when the tap operation is performed on the move-to-first button Bf, after the termination of the processing of changing the display of the thumbnail image T on the liquid crystal panel 115 from the last to the first, the last thumbnail image Te is displayed.

However, the invention is not limited to this. For example, when the operation relating to the information, which represents the thumbnail image T at one end, is performed, the CPU 110 may display the thumbnail image T at the other end after a different predetermined time (for example, a certain time of 5 seconds or the like) elapses.

### 2-8. Another Embodiment 8

In the above-mentioned embodiment, the DSC 100 is configured to display images in series in accordance with the flick operation performed on the touch panel 113. However, the invention is not limited to this, and the DSC 100 may be configured to display images in series in accordance with various different operations. For example, instead of the touch panel 113, a hardware button such as an arrow key may be provided as an input section. In this case, the images may be displayed in series in accordance with the operation performed on the hardware button such as the corresponding arrow key.

### 2-9. Another Embodiment 9

In the above-mentioned embodiment, the thumbnail images T of the images captured by the DSC 100 are displayed in series, and the move-to-last button Be or the move-to-first button Bf is displayed when the first thumbnail image Tf or the last thumbnail image Te is displayed.

However, the invention is not limited to this, and various different images (for example, downloaded images photo images of music album jackets, and the like) may be displayed in series, and the move-to-last button Be or the move-to-first button Bf may be displayed when the first image or the last image is displayed.

### 2-10. Another Embodiment 10

In the above-mentioned embodiment, while the CPU 110 displays the first thumbnail image Tf, the scroll operation may be performed in the upward direction. In this case, the CPU 110 displays the move-to-last button Be. Further, in the above-mentioned embodiment, while the CPU 110 displays the last thumbnail image Te, the scroll operation may be performed in the downward direction. In this case, the CPU 110 displays the move-to-first button Bf.

However, the invention is not limited to this, and the CPU 110 may display the move-to-last button Be or the move-to-first button Bf at various different timings while displaying the first thumbnail image Tf or the last thumbnail image Te. For example, when the last thumbnail image Te is displayed on the liquid crystal panel 115, the CPU 110 may immediately display the move-to-first button Bf.

### 2-11. Another Embodiment 11

In the above-mentioned embodiment, the DSC 100 as the display apparatus 1 is provided with the liquid crystal panel 115 as the display section 2 and the CPU 110 as the control section 4.

However, the invention is not limited to this. For example, the respective functional sections of the above-mentioned DSC 100 may be formed as various different hardware and software if only those have the same functions.

Further, for example, the DSC 100 may be provided with a liquid crystal display, which has a touch panel function, instead of the touch screen 109 constituted by the liquid crystal panel 115 and the touch panel 113. Furthermore, instead of the touch panel 113, a hardware button such as an arrow key may be provided. In addition, instead of the liquid crystal panel 115, an organic EL (Electro Luminescence) display or the like may be provided.

In the above-mentioned embodiment, the invention is applied to the DSC 100. However, the invention is not limited to this. For example, the invention may be applied to various different apparatuses such as a digital video camera, a personal computer, and a mobile phone if the apparatuses display images in series.

### 2-12. Another Embodiment 12

In the above-mentioned embodiment, the program to execute various processing is stored in the ROM 111 of the DSC 100.

However, the invention is not limited to this, and the program may be stored in the storage medium such as a memory card so as to be read out from the storage medium and be executed by the CPU 110 of the DSC 100. Further, instead of the ROM 111, a flash memory may be provided, and the program, which is read out from the storage medium, may be installed in the flash memory.

### 2-13. Another Embodiment 13

Further, the invention is not limited to the above-mentioned embodiments and other embodiments. That is, the technical scope of the invention involves embodiments obtained by combinations of some parts or the entireties of the above-mentioned embodiments and other embodiments or embodiments obtained by extracting some parts of those. For example, the embodiment 1 may be combined with the embodiment 2.

The present application contains subject matter related to that disclosed in Japanese Priority Patent Application JP 2009-182775 filed in the Japan Patent Office on Aug. 5, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display apparatus comprising:
a display section that displays an image; and
a control section that allows the display section to display a plurality of images, which are included in a predetermined group, in series on the basis of a predetermined operation performed on an input section, and allows the display section to display predetermined information while allowing the display section to display an endmost image in the corresponding predetermined group.

2. The display apparatus according to claim 1, wherein while allowing the display section to display the endmost image in the predetermined group, the control section allows the display section to display the predetermined information when an operation to display the next image is performed on the input section.

3. The display apparatus according to claim 2, wherein while allowing the display section to display the endmost image at one end of the predetermined group,
the control section allows the display section to display information, which represents the image at the one end of the predetermined group, as the predetermined information when the operation to display the next image is performed on the input section, and
the control section allows the display section to display the image at the other end of the predetermined group when an operation relating to the corresponding information is performed on the input section.

4. The display apparatus according to claim 3, wherein when allowing the display section to display the image at the other end of the predetermined group by performing the operation relating to the information on the input section, the control section allows the display section to display the information, which represents the image at the other end of the predetermined group, as the predetermined information.

5. The display apparatus according to claim 3, wherein when the operation relating to the information is performed on the input section, the control section hides the image at the one end of the predetermined group, and after a predetermined time elapses, allows the display section to display the image at the other end of the predetermined group.

6. The display apparatus according to claim 2, wherein while allowing the display section to display the endmost image at one end of the predetermined group,
the control section allows the display section to display the predetermined information when the operation to display the next image is performed on the input section, and
the control section allows the display section to display an image, which is included in a group other than the predetermined group, when an operation relating to the predetermined information is performed on the input section.

7. The display apparatus according to claim 1, wherein the control section allows the display section to display the predetermined information during a predetermined time, and subsequently hides the predetermined information.

8. The display apparatus according to claim 2, wherein while allowing the display section to display the endmost image at one end of the predetermined group,
the control section allows the display section to display information, which represents the image at the one end of the predetermined group, as the predetermined information when the operation to display the next image is performed on the input section, and
the control section allows the display section to display the image at the other end of the predetermined group when the operation to display the next image is performed on the input section after the corresponding information is displayed.

9. The display apparatus according to claim 1, wherein in a case where the number of the images which are included in the predetermined group is larger than the number of images which can be displayed in a display screen of the display section, the control section allows the display section to display the predetermined information when allowing the display section to display the endmost image in the predetermined group.

10. The display apparatus according to claim 1, wherein the control section allows the display section to display information, which informs the endmost image in the predetermined group, as the predetermined information.

11. A display method comprising the steps of:
allowing a display section to display a plurality of images, which are included in a predetermined group, in series on the basis of a predetermined operation performed on an input section, through a control section of a display apparatus; and
allowing the display section to display predetermined information while allowing the display section to display an endmost image in the corresponding predetermined group, through the control section of the display apparatus.

12. A display program causing a display apparatus to execute the functions of:
allowing a display section to display a plurality of images, which are included in a predetermined group, in series on the basis of a predetermined operation performed on an input section, through a control section of a display apparatus; and
allowing the display section to display predetermined information while allowing the display section to display an endmost image in the corresponding predetermined group, through the control section of the display apparatus.
